(19) United States
(12) Patent Application Publication
(10) Pub. No.: US 2019/0159487 A1
(43) Pub. Date: May 30, 2019

(54) Reduction of oxidation from consumer organic products by electric field

(71) Applicant: Thomas E. Terwilliger, Pompano Beach, FL (US)

(72) Inventor: Thomas E. Terwilliger, Pompano Beach, FL (US)

(21) Appl. No.: 15/828,025

(22) Filed: Nov. 30, 2017

(51) Int. Cl. A23L 3/32; A23B 7/015

(52) U.S. Cl. CPC A23L 3/325; A23B 7/015

(57) ABSTRACT

The present invention relates to a process and system using induction of electric voltage to reduce the oxidation of consumer organic products. In particularly, chemical reactions within the AC and/or DC field are influenced by a catalytic reaction caused by the changing the field to reduce and/or eliminate oxidation in consumer organic products.

### CROSS-REFERENCE TO RELATED APPLICATION

The present application is based on, and claims the benefit of priority of U.S. application Ser. No. 62/276,094 filed on Dec. 27, 2016, the disclosure of which is hereby incorporated by reference herein in its entirety.

### BACKGROUND OF INVENTION

### 1. Field of Preferred Embodiment

The present invention relates to process and system using the induction of electric voltage to reduce the oxidation of consumer products.

### 2. Background Art

Expired consumer organic products encourage waste and, conversely, numerous products often degrade while still within the expiration date. These products may encounter very different environmental insults after distribution. The current system exposes manufacturers and retailers to liability is frequently not utilized, seen or understood by consumers. The present invention provides systems and methods for reducing oxidative changes in an article, wherein the article is subject to degradation or spoilage in the presence of air or oxidative conditions.

Expiration dates for consumer products have been in use for decades. The current system of expiration dates assigns one relatively conservative estimate of product life prior to opening. These products may encounter very different environmental insults after distribution. Conservative expiration dates encourage waste and, conversely, numerous products often degrade while still within the expiration date. The current system exposes manufacturers and retailers to liability and the printed expiration information is frequently utilized, seen or understood by consumers.

Atoms are combined to form molecules. An atom consists of a nucleus surrounded by circling electrons. These electrons can be forced by external energy to align themselves, or to break away from the nucleus, in which case they are said to cause ionization, or free radicals.

One example of ionization is electro-plating using a solution. A direct current voltage is passed through a chemical solution causing positive ions to flow in one direction and negative ions to flow in the opposite direction in the solution. This can cause the desired ionized chemical to accumulate on one pole of the applied electrical energy. The same principle applies to the common automobile storage battery, where charging causes the desired atoms or molecules to accumulate on one plate and discharging results in an opposite ion flow. Electrolysis to produce hydrogen and oxygen from water is another example. It is the object of the present invention to cause similar catalytic reactions by external electromagnetic means instead of electrolytic means.

When the field varies in level, or change direction, a voltage is induced in all the atoms and molecules within that field. Changing the field causes ionization by inducing a voltage in the molecules. It is an object of the present invention to cause ionization changes and molecular alignment of a single polarity as long as a specially designed alternating the field, which is not a sine wave, is applied.

The level of the induced voltage varies according to the conductivity, dielectric constant permeability of the material, and with the frequency of the changing magnetic energy, as well as to the input energy level. These levels are predictable from Maxwell's equations.

The level of the induced voltage, which causes ionization, varies according to the dielectric constant, conductivity and permeability of the material, and with the frequency of the changing magnetic energy, as well as to the input energy level. The molecules of the material are assumed to exhibit a characteristic similar to an inductance so that a voltage is induced by the changing the field. The induced voltage applies only to pure AC (sine waves), as in a microwave oven, or radio frequency heater. L is the equivalent inductance of the material. The current flows in the material, which determines the heating effect, is dependent upon the resistivity of the material.

Assume a coil wrapped around a magnetic metal core. If an alternating current is applied, the electrons will tend to align in one direction on one field polarity and in the opposite direction on the alternate field polarity. The net result is no permanent alignment and the only effect is heating if the energy and frequency are high enough. A direct current applied will have no more effect than a permanent magnet. If there is no changing field, there is no induced voltage to cause ionization changes. The AC current here is assumed to be Bipolar, as with a sine wave.

The applied current and the derived field is Unipolar, as derived from a shaped wave input. An ionizing voltage will be induced as the voltage rises and a reverse voltage will appear as the magnetic flux decreases. The reverse voltage can be “self-induced” from energy stored in the coil. If the flux density and the rise and decay times of the voltages differ, the energy stored and released in the coil is not 100% bidirectional. A lingering unidirectional alignment of the electrons remains, causing a constant ionization effect in the material within the field of influence of the coil. The ionization causing effect ceases when the unipolar power is removed. The ionizing voltage when the charge and discharge effects are not equal, varies according V∝KL(Δϕ/Δt), which is a more accurate equation for the present invention than that for balanced AC, since the rise and fall of the current due to the flux Φ in the field is not equal for the same period t. Expressed differently, more energy is sent out in a unipolar direction than returns in the self-induced field collapse. This is similarly to the hysteresis effect.

If the material in the ionization field is a foodstuff or liquid, the effect is unknown. However, the taste is usually changed. The presence of ions affects the sense of smell and the taste. Ozone for example can be smelled, whereas oxygen cannot. Acids are highly ionized solutions and have a noticeable taste. The effect on chemicals in general varies according to what is being processed and how it is being processed. The varying field can be shown to be having a catalytic effect by changing the ph. of the material under treatment. Changes in color of certain electrolytes have also been noticed when subject to unipolar fields.

An ionizing effect can be obtained in a manner similarly to an electro-plating tank, or automobile battery, when two plates are submerged into a solution (electrolysis). The same ionizing effect can be obtained from a changing unipolar field. In this case the subject material absorbs energy and generates a voltage from the field as shown by the equations above. The ionizing voltage need not be large, since it is known that batteries can be ‘trickle charged’ and electro-plating and electrolytic action can occur very slowly at very low voltages and currents.

The catalytic effect to change the nature of a chemical is well known in treating exhaust gases and in the refining of petrochemicals. This effect is usually caused by the presence of an H+ proton, which could be an ionized hydrogen atom. The well known pH meter used with liquids measures H+ ion activity.

The ionization, and/or molecular alignment of the molecules in a substance, which is then subject to a second process such as heating, cooking, or burning, can be shown to exhibit a catalyzing effect. Catalyzers can be used to cause or to reduce certain chemical reactions.

De-ionization, or the reduction in free radicals, is also observed in most cases. The electrolyte in an electroplating bath is depleted, or exhausted, by removing ions. Subjecting coffee or tea or other organic substance to electrolysis reduces the acidity as indicated by the increase in resistivity and decrease in ph.

In the simplest de-ionization embodiment, two plates are immersed in an electrolyte and a polarized direct current is applied to cause ionization. This is prior art, as in the production of hydrogen and oxygen.

As a test example, ordinary municipal tap water containing a low level of mineral impurities such as calcium carbonate, some iron compounds and water softener salt, was used as the electrolyte. A DC potential from a battery equivalent source was used to increase ionization in the water.

At the start of the process, the resistance between the plates measured 560 Kilo Ohms. After 20 minutes the resistance increased to 1.5 Mega Ohms and after 1 hour the resistance was greater than 20 Mega Ohms, indicating that the salts were extracted from the electrolyte and deposited as inert substances on the plates, thus depleting the electrolyte. This resistance change provides an additional means of measuring the long-term effects of the ionization or de-ionization.

### DETAILS OF INVENTION

The present invention relates to a process and system for extending the shelf life of consumer organic products and reducing oxidation (the rotting process) of plant and organic substances by induction of a replacement electron lost in oxidation of extracted compounds.

In one preferred embodiment of the present invention, radio frequency (RF) field using a specially altered waveform, or flux pattern, changes the ionization in some substances within that field that can have effect on the substance within the treatment container, which is the electrolyte.

In another preferred embodiment of the present invention, the process begins with a coil that is used to produce the field is wound around the lip of a pot. This creates an expanding and collapsing field within the pot to act upon the electrolyte. The rise and fall times of the exciting voltage is altered. An unequal, or unbalanced, voltage is thereby introduced across the molecules in the container to cause an ionization effect. The container itself serves as a magnetic core of high permeability to shape the field. The container may be operated over a heating source, thus combing external heat with the ionizing energy from the coil to influence the chemical reaction within the container. The dielectric constant of the electrolyte greatly influences the magnetic effect upon the electrolyte.

In another preferred embodiment of the present invention, a coil wound around the lip of the pot. The diodes cause the voltage and current in the coil to be unequal in outgoing and incoming energy, with the drive energy being greater than the self-induced energy when the field collapses.

A common balanced field, as would be generated by normal alternating current, cannot be used for this purpose since more energy must be sent out in flux power than is returned by the collapsing field. Some of the energy is absorbed in the iron of the pot and some in heating, or converting, the electrolyte. This transfer of energy is well known in industry where RF heating is used in metal processing. Microwave ovens are an example of the electrolyte (dielectric) heating. Shaping the voltage waveform applied to the coil can cause this loss, or energy transfer effect to an electrolyte, to be maximized.

In experiments using various substances as electrolytes, such as tea and coffee, it was found the resistivity of the electrolyte could be increased by exposure to the varying field. A circuitry used to obtain the varied magnetic flux strength and to measure the DC offset caused by the unipolar field. Normally, a balanced RF field would produce no direct current from the pickup coil. In the tests conducted with unipolar fields, a DC potential greater than 30 mV was observed anywhere within the container electrolyte. This would vary according to the primary and/or secondary that turns ratio and the applied power level.

Still another preferred embodiment of the present invention, the coil that is used to produce the field is wound around a Ferro magnetic core that is placed alongside a non ferrous pipe transferring chemicals for further processing. The material within the pipe is then subjected to the ionizing energy and to molecular alignment if applicable. The core and pipe may be so arranged that the field is not centered in the center of the pipe.

In another embodiment of the present invention, the power for the oscillator and coil driver to produce the RF field is obtained from a Peltier device which has a voltage output, the level of which is dependent upon heat difference.

In a further embodiment of the present invention, this voltage level causes the oscillator to vary in frequency. A receiving device near the processing pot can pick up this oscillator signal frequency and use it to control temperature by measuring the frequency. In this case the pot is totally portable and not connected direct to an external energy source.

Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings.

It should be understood that the present invention is not limited to the embodiments disclosed, but is capable of numerous rearrangements, modifications, and substitutions of parts and elements without departing from the spirit of the invention. 9. A system using the process of claim 1 for reduction of oxidation in consumer organic product, comprising a consumer organic product which is subject to degradation or spoilage in the presence of air or oxidative conditions; a colorimetric indicator comprising a colored compound which changes color upon oxidation; wherein said indicator is exposed to substantially the same environmental conditions as said consumer organic product; and a reference standard, whereby comparison of the color of said indicator with said reference standard determines the presence or absence of oxidative changes in said consumer organic product.

1. A process for reduction of oxidation from liquid product having degradation or spoilage comprising:
producing an induction of electric field by using a coil wound around a container of said liquid product, wherein said liquid product is exposed to expanding and collapsing said electric field, and wherein said electric field is changeable upon an electrolyte by inducing low voltages and currents; and
altering induced voltage for creating ionization effect within said container to replace electron loss in oxidation of said liquid product, until DC offset caused by unipolar field is about greater than 30 mV.

2. (canceled)

3. (canceled)

4. (canceled)

5. (canceled)

6. The process according to claim 1, wherein at least one of the one or more characteristics of said liquid product is selected from the group consisting of resistivity, temperature, pH, and any combination thereof.

7. (canceled)

8. (canceled)

9. A system using the process of claim 1 for reduction of oxidation in consumer organic product, comprising a consumer organic product which is subject to degradation or spoilage in the presence of air or oxidative conditions; a colorimetric indicator comprising a colored compound which changes color upon oxidation; wherein said indicator is exposed to substantially the same environmental conditions as said consumer organic product; and a reference standard, whereby comparison of the color of said indicator with said reference standard determines the presence or absence of oxidative changes in said consumer organic product.

10. The process according to claim 1 further comprises producing said electric field by using a coil for creating an expanding and collapsing electric field.

11. The process according to claim 1, wherein said container serves as magnetic core having permeability to shape the electric field.
